(19) United States
(12) Patent Application Publication
(10) Pub. No.: US 2013/0124301 A1
(43) Pub. Date: May 16, 2013

(54) SYSTEM AND METHOD FOR DYNAMIC USER FEEDBACK FOR DISPLAY AND CONTEXT ADVERTISEMENTS

(71) Applicant: Michael P. BACHMAN, Sunnyvale, CA (US)

(72) Inventor: Michael P. BACHMAN, Sunnyvale, CA (US)

(73) Assignee: Google Inc.

(21) Appl. No.: 13/293,836

(22) Filed: Nov. 10, 2011

(51) Int. Cl. G06Q 30/02

(52) U.S. Cl. 705/14.44

(57) ABSTRACT

Methods, systems, and computer programs encoded on a computer storage medium include for an ad to be displayed on a web page, providing a first user input field that is selectable by a user viewing the ad. Upon detection of actuation of the user input field for the ad, providing display data representing a second user input field by which a user can enter feedback information regarding the ad is provided, the second user input field comprising a portion configured to receive input from the user regarding a specific portion of the ad. There is received feedback information regarding the ad that has been entered using the second user input field. The feedback information is stored in association with the ad.

### BACKGROUND

The Internet provides access to a wide variety of content. For instance, images, audio, video, and web pages for many different topics are accessible through the Internet. The accessible content provides an opportunity to present advertisements to users. Advertisements can be placed within content, such as a web page, image or video, or the content can trigger the display of one or more advertisements, such as presenting an advertisement in an advertisement slot within the content and/or in an advertisement slot of a pop-up window or other overlay.

Advertisers decide the web sites on which they want their ads to be displayed, whereby ad auctions determine whether or not the advertiser's ad will actually be shown to the user visiting a web site, or whether other ads will beat out the ad at issue and be shown instead to the user. Ad auctions rely on many different criteria to determine which ads are to be displayed to a user, such as budget and/or bid made by an advertiser for an ad, predicted click through rate (pctr) for the ad, relevancy of the web site to relevancy information provided by the advertiser with respect to the ad (e.g., a search phrase or web site genre information to be associated with the ad), etc.

When a user sees an ad on a web pate, that ad might be offensive to the user, due to images and/or text associated with the ad.

### SUMMARY

In general, one innovative aspect of the subject matter described in this specification relates to enabling a user to provide dynamic feedback with respect to an ad that the user is currently viewing on a web page or on a search results page.

Various embodiments of an ad feedback method include for an ad to be displayed on a web page, providing a first user input field that is selectable by a user viewing the ad; upon detection of actuation of the first user input field for the ad, providing display data representing a second user input field by which a user can enter feedback information regarding the ad, the second user input field comprising a portion configured to receive input from the user regarding a specific portion of the ad; receiving the feedback information regarding the ad that has been entered using the second user input field; and storing the feedback information in association with the ad.

Various embodiments of a non-transitory computer readable medium storing computer program product, which, when executed by at least one computer, causes the at least one computer to perform the functions of:

for an ad to be displayed on a web page, providing a first user input field that is selectable by a user viewing the ad;

upon detection of actuation of the first user input field for the ad, providing display data representing a second user input field by which a user can enter feedback information regarding the ad, the second user input field comprising a portion configured to receive input from the user regarding a specific portion of the ad;

receiving the feedback information regarding the ad that has been entered using the second user input field; and
storing the feedback information in association with the ad.

Various embodiments of an ad feedback method include for an ad to be displayed on a web page, providing a first user input field that is selectable by a user viewing the ad, and providing display data representing a second user input field by which a user can enter feedback information regarding the ad, the display data being configured to display the second user input field upon detection of actuation of the first user input field, the second user input field further configured to receive input from the user regarding a specific portion of the ad; receiving the feedback information regarding the ad that has been entered using the second user input field; and storing the feedback information in association with the ad.

Various embodiments of a non-transitory computer readable medium storing computer program product, which, when executed by at least one computer, causes the at least one computer to perform the functions of:

for an ad to be displayed on a web page, providing a first user input field that is selectable by a user viewing the ad, and providing display data representing a second user input field by which a user can enter feedback information regarding the ad, the display data being configured to display the second user input field upon detection of actuation of the first user input field, the second user input field further configured to receive input from the user regarding a specific portion of the ad;

receiving the feedback information regarding the ad that has been entered using the second user input field; and

storing the feedback information in association with the ad.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram of an example environment in which an advertisement management system manages advertising services in accordance with an illustrative embodiment.

FIG. 2 shows an advertisement with a feedback icon provided on it, consistent with various embodiments of the invention.

FIG. 3 shows a feedback pop-up window provided adjacent an advertisement, consistent with various embodiments of the invention.

FIG. 4 shows a marked up advertisement to be sent with the feedback, consistent with various embodiments of the invention.

FIG. 5 shows a feedback preview pop-up window, consistent with various embodiments of the invention.

FIG. 6 is a block diagram showing elements for directing advertisement feedback to appropriate departments within a company, consistent with various embodiments of the invention.

FIG. 7 is a block diagram of a computer system in accordance with an illustrative embodiment.

Like reference numbers and designations in the various drawings indicate like elements.

### DETAILED DESCRIPTION

One or more embodiments may provide the capability for a user to provide dynamic feedback concerning an ad that the user is currently viewing on a web page. One or more embodiments may provide the use of the feedback information in modifying a ranking of an ad to be used for future ad auctions.

As used throughout this document, user interactions include any presentation of content to a user and any subsequent affirmative actions or non-actions (collectively referred to as “actions” unless otherwise specified) that a user takes in response to presentation of content to the user (e.g., selections of the content following presentation of the content, or non-selections of the content following the presentation of the content). Thus, a user interaction does not necessarily require a selection of the content (or any other affirmative action) by the user. For example, the user reviewing content for a period of time may be considered an interaction. A user interaction may also include a user typing in the URL of a content provider directly into the web browser.

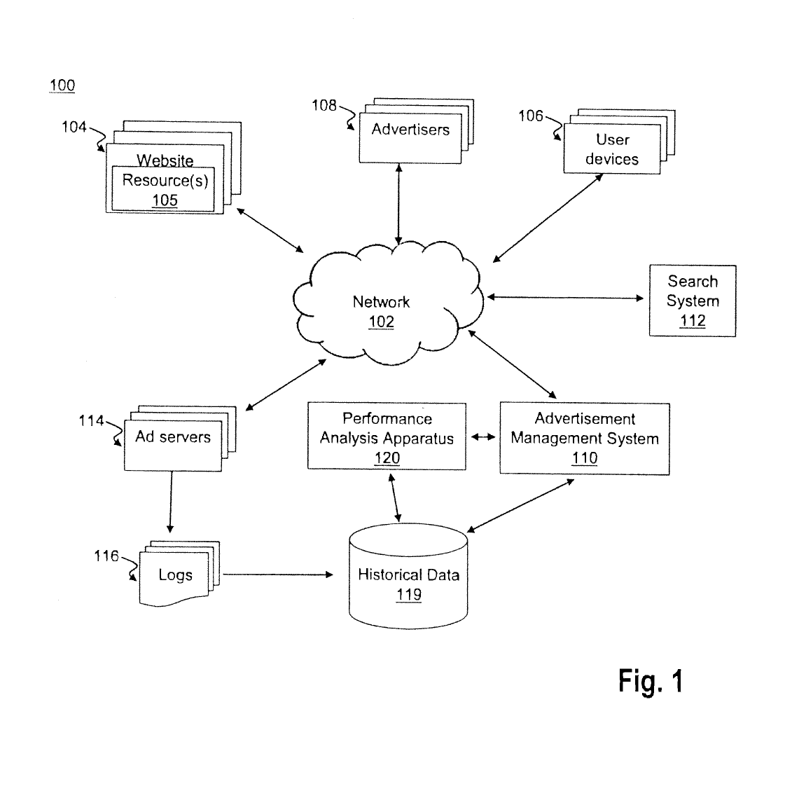

FIG. 1 is a block diagram of an example environment in which an advertisement management system manages advertising services consistent with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources 105 can include web pages, word processing documents, portable document format (PDF) documents, images, video, programming elements, interactive content, and feed sources, to name only a few. The resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages, such as, JavaScript® or ECMAScript®.

A user device 106 is an electronic device that is under control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources 105 provided on the websites 104. Data about the resources 105 can be indexed based on the resource 105 with which the data is associated. The indexed and, optionally, cached copies of the resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies the resources 105 that are responsive to the query, provides information about the resources 105 in the form of search results and returns the search results to the user devices 106 in search results pages. A search result can include data generated by the search system 112 that identifies a resource 105 that is responsive to a particular search query, and can include a link to the resource 105. An example search result can include a web page title, a snippet of text or a portion of an image extracted from the web page 104, a rendering of the resource 105, and the URL of the web page 104. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When a resource 105 or search results are requested by a user device 106 or provided to the user device 106, the advertisement management system 110 receives a request for advertisements to be provided with the resource 105 or search results. The request for advertisements can include characteristics of the advertisement slots that are defined for the requested resource 105 or search results page, and can be provided to the advertisement management system 110. For example, a reference (e.g., URL) to the resource 105 for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource 105 (“resource keywords”) or a search query for which search results are requested can also be provided to the advertisement management system 110 to facilitate identification of advertisements that are relevant to the resource 105 or search query.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects (i.e., clicks) a presented advertisement, data representing the selection of the advertisement can be stored in the log file 116, a cookie, or the historical data store 119. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106.

The log files 116, or the historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

Embodiments of the invention provide the capability for a user to submit dynamic feedback information regarding an ad that the user is currently viewing on a web page or on an online search results screen (based on a text or image-based search requested by the user).

Implementations disclosed herein may provide a clearer way or streamlined mechanism for reporting inappropriate ads, irrelevant ads and/or offensive ads, so that those ads can be pulled from being considered for future ad auctions.

Implementations disclosed herein can be used in the advertisements environment to allow users to flag ads that they see that are deemed by the user to merit feedback to an ad monitoring service or an ad providing service, such as Google AdWords or Google Adsense.

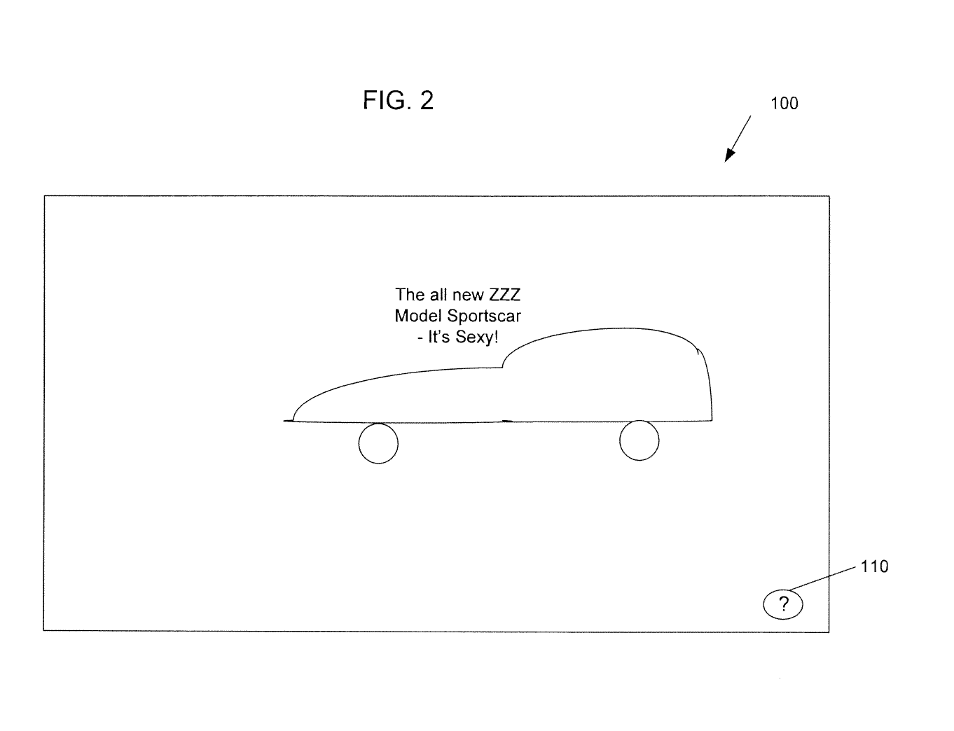

FIG. 2 shows a vehicle advertisement 100 according to an exemplary embodiment. That advertisement 100 is provided on a web page viewed by a user, for example, a web page of an automobile magazine that the user is currently visiting. The advertisement is displayed to the user based on the advertisement 100 winning an auction resulting from the user visiting a particular web page that allows ads to be displayed along with its own content, for example, or by the user requesting an online search for sports cars in which the ad is shown at a predetermined portion of a search results screen (e.g., above the search results or to the right of the search results). The advertisement 100 comprises an icon 110 which may be provided on the periphery of the advertisement 100, for which a user can click on that icon 110 and thereby provide feedback regarding the advertisement 100. In FIG. 2, the icon 110 is shown as a small question mark (“?”) on the bottom right portion of the automobile advertisement 100. Other icons and locations of the icon are possible while remaining within the spirit and scope of the invention. For example, the icon can be provided adjacent to the advertisement, but not actually on it.

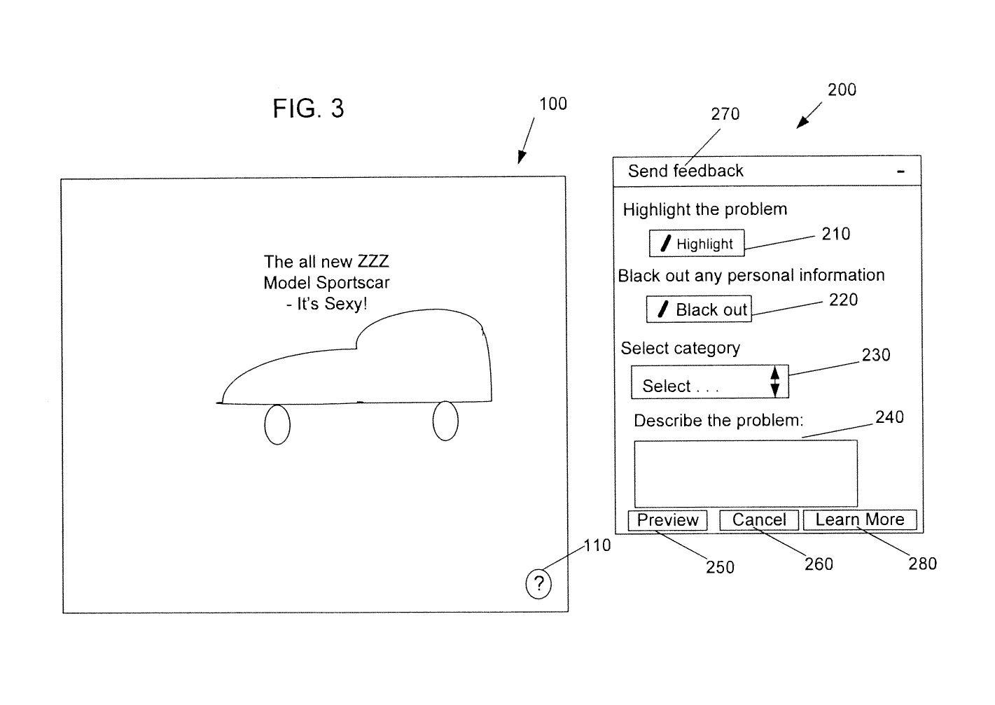

When a user clicks on the icon 110, a pop-up window 200 appears adjacent to the advertisement 100, as shown in FIG. 3. In the pop-up window 200, the user has the ability to highlight, identify or specify the issue that the user has with the ad by clicking on a highlight button 210 (which may include a pencil icon to indicate to the user that he/she can mark-up portions of the ad). The user also has the ability to black out or remove any personal information when sending the feedback by clicking on a black out button 220 (which includes a pencil icon to indicate to the user that he/she can blacken portions of the ad or screen shot before they are sent back to the server). The user further has the ability to select a category of feedback in a feedback type region 230. Also, the user has the ability to describe the problem by including text in a feedback text region 240 and preview the feedback by clicking on a Preview button 250. Still further, the user can cancel the sending of feedback by clicking on a Cancel button 260, and the user can send the feedback by clicking on a Send Feedback button 270 at the top left of the pop-up window 200. Additionally, the user can learn more about the advertisement feedback feature by clicking on the Learn More button 280 at the bottom right of the pop-up window 200.

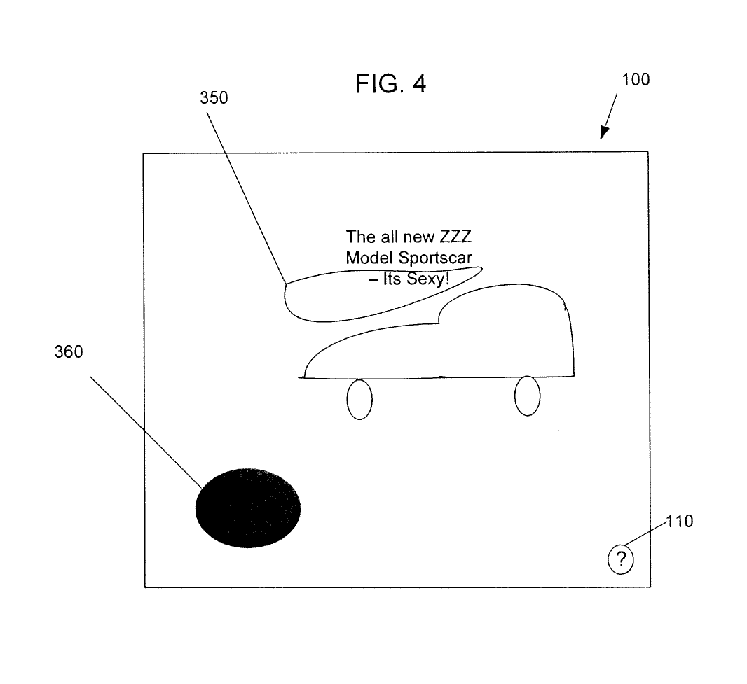

Referring now to FIG. 4, which shows the highlight feature of providing feedback, a user can move his/her mouse point over the advertisement to allow the user to highlight certain portions of the advertisement that are of concern to the user. A drawing application may be utilized to provide for this feature, such as providing a way for the user to circle or otherwise markup up portions of the advertisement that are the basis of the feedback being provided by the user. That is, when the user clicks on the highlight button 210 as shown in FIG. 3, a drawing software application is opened, which allows the user to mark up the advertisement in a particular manner (e.g., from a line based on mouse movement over the advertisement to allow the user to circle the area of the advertisement that merits the feedback) so as to show the user's concern with the advertisement.

In particular, FIG. 4 shows a line 350 made by a user to encircle a particular portion of the advertisement 100 after the user clicked on the highlight button 210, in which the line 350 is included in the feedback sent out when the user hits a Send Feedback button. In some embodiments, a screen shot is taken of the marked-up advertisement when the user has finished marking it up, and that screen shot is included in the ad feedback. In the example shown in FIG. 4, the user does not like the use of “Its Sexy” in the advertisement text, and so has encircled those words in the advertisement with the line 350 created by the user moving his/her mouse along the path of the line 350.

The black out button 220 shown in FIG. 3 allows the user to provide anonymous feedback, in which the user's identity is removed from the feedback information provided. For example, cookie information is removed from the feedback information when the user clicks on the black out button 220, and any personal information of the user that may be associated with the web page on which the advertisement is displayed is also removable, such as by the user clicking on a portion of the web page and blackening that portion of the web page so that it is not included in the advertisement feedback message. In FIG. 4, a blacked out portion 360 of the advertisement 100 is shown based on the users moving his/her mouse over that area when the black out button was selected, whereby that portion contains information that the user does not want to include with the advertisement feedback.

Additionally, geographic information of the user can be blocked when the user clicks on the black out button 220. If the user does not click on the black out button 220, the geographic information of the user can be determined based on the online browser used by the user to access the Internet, for example, whereby this information may be useful in determining if certain ads are offensive only to persons living in a particular country or region of a country, and whereby those ads can be blocked in the future from being shown to a particular geographical location based on this data.

The feedback type region 230 of the pop-up window 200 allows the user to select from a list of predetermined categories of feedback type. By way of example, the list may include: a) offensive advertisement, b) inappropriate advertisement for the web page that it is displayed on, c) issue with how advertisement looks on the web site, d) other feedback issue, etc.

The feedback text region 240 enables the user to enter in text describing what is the basis for the advertisement feedback, and allows the user to more particularly describe the user's issue with the advertisement. By way of example, the feedback text region 240 allows a computer (e.g., a server) to receive from the user a predetermined number of characters, e.g., 200 characters, in which that text is included in the user feedback provided to an advertisement review department.

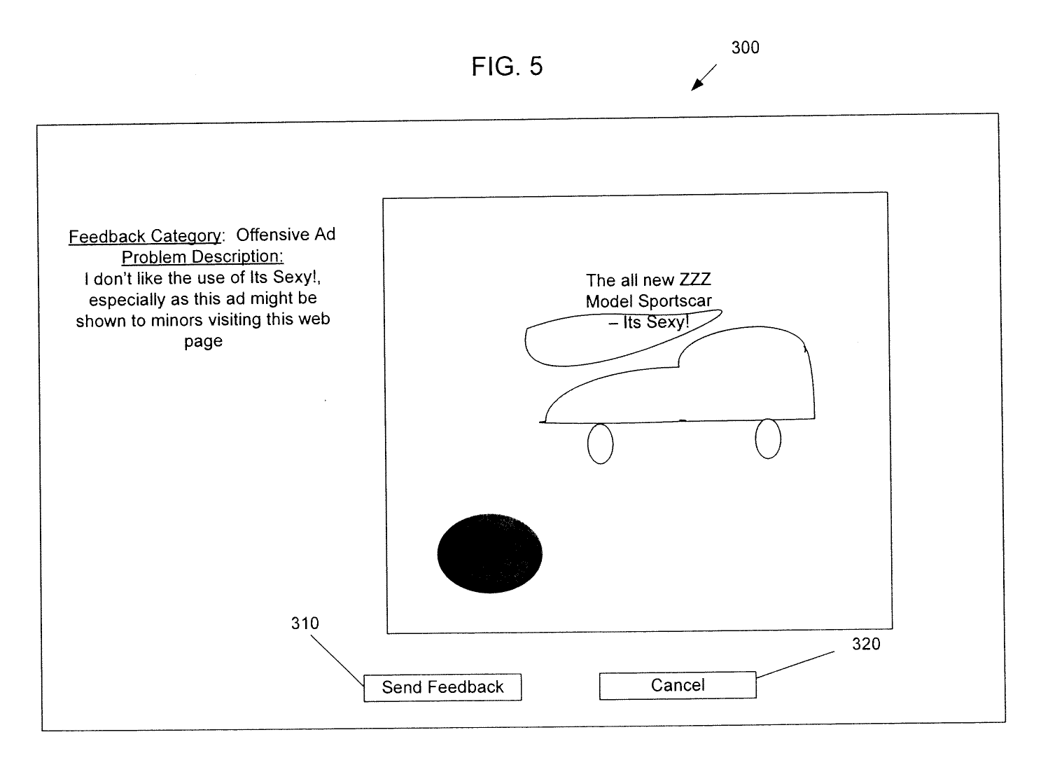

The Preview button 250 allows the user to preview the feedback prior to it being sent out. When the Preview button 250 is clicked, a Preview pop-up window 300 opens up, as shown in FIG. 5. The Preview pop-up window 300 shows the feedback that will be provided to an advertisement review department, and allows the user to make any changes to the feedback prior to sending it out. The Preview pop-up window 300 includes a Send Feedback button 310, as shown in FIG. 5, which the user can click in order to send out the advertisement feedback. The Preview pop-up window 330 also includes a Cancel button 320, which allows the user to cancel the sending of the advertisement feedback. A Cancel button 260 and a Send Feedback button 270 are also provided on the initial feedback pop-up window, as shown in FIG. 3.

The feedback data is provided to a relevant third party, such as an advertisement review department of an advertisement auction company (that being a company that auctions advertisements for inclusion on web pages). The feedback data can additionally be sent to the advertiser in some embodiments, to allow the advertiser to change the ad so as to remedy the situation. The feedback data can be used to lower an advertisement's rating that is used for future advertisement auctions, for example. For example, advertisement information is entered by an advertiser when the advertiser wants the advertisement to be considered for ad auctions. An advertiser enters a bid for an advertisement, which is the amount that the advertiser agrees to pay each time the ad is clicked by a user when the ad is displayed on a web page. The advertiser also may enter relevancy information, which may correspond to key word phrases associated with key word searches performed by online users, and/or web site genres for websites that the advertiser wants the advertisement displayed. That information collectively is used in an ad auction to provide a score or rating for an ad, to be compared with other ads competing in the same ad auction. In some embodiments, negative feedback on an ad as provided by online users can be used to lower the score or rating for the ad.

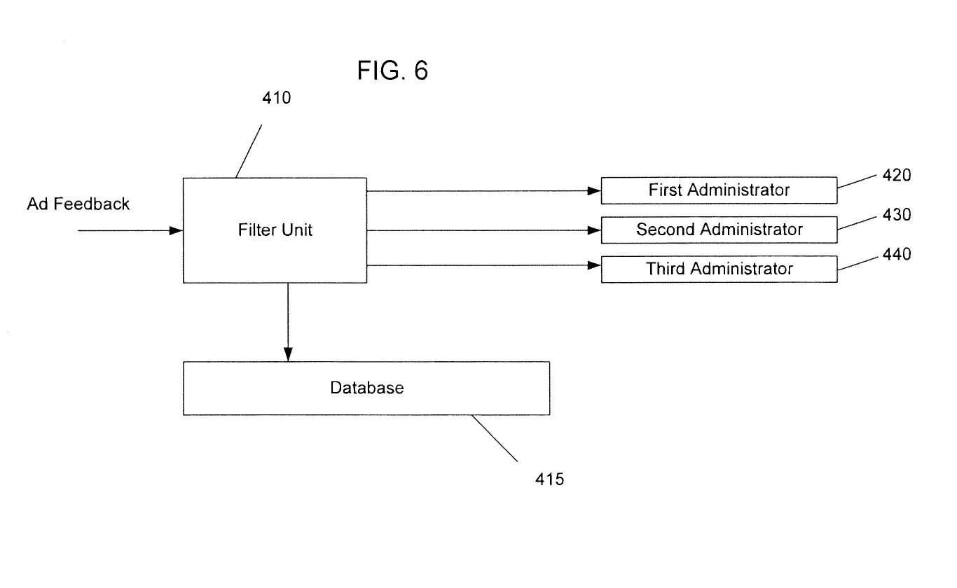

In some embodiments, the ad feedback is filtered based on the category of ad feedback entered by the user, and then sent to an appropriate person or department which is assigned to deal with that particular type of ad feedback. FIG. 6 shows a filter unit 410 that filters ad feedback based on the type of ad feedback, whereby the ad feedback is stored in a database 415 and also provided to either an email of a first administrator 420, a second ad administrator 430, or a third administrator 440, based on whether the ad feedback is based on a first ad feedback category, a second ad feedback category, or a third ad feedback category, as determined by the user's selection in the feedback type region 230 of the ad feedback popup window (see FIG. 3). By providing feedback to the correct persons or departments of an ad monitoring company in a streamlined manner at run time (that is, while a user making the feedback may still be online), quick decisions can be made with respect to pulling offensive or inappropriate ads from being viewed by persons on the Internet. An application can be utilized to forward ad feedback to the relevant persons or departments, based on the category of the ad feedback as chosen by the user who sent the feedback.

The use of the ad feedback can be used for either content ads or search ads. Content ads are provided to online users based on the content of a web site that the user visits, and search ads are provided to online users based on online keyword and/or image searches performed by users.

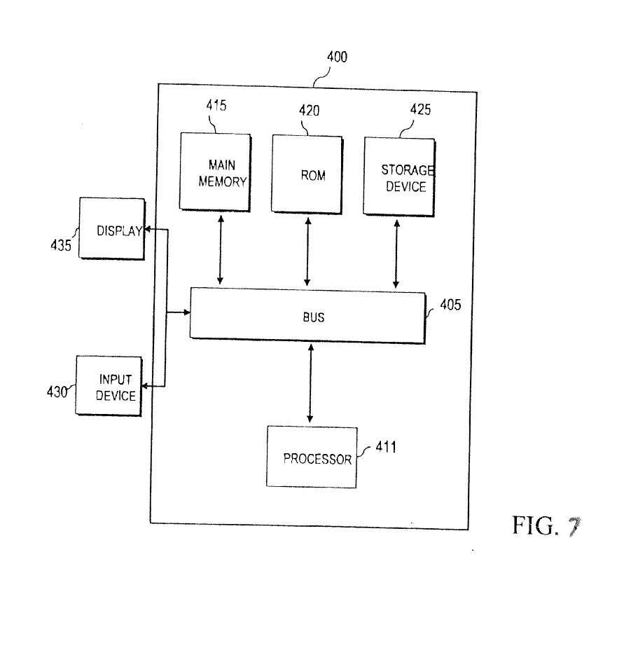

FIG. 7 illustrates a depiction of a computer system 800 that can be used to receive and process ad feedback data. The computing system 800 includes a bus 805 or other communication mechanism for communicating information and a processor 810 coupled to the bus 805 for processing information. The computing system 800 also includes main memory 815, such as a random access memory (RAM) or other dynamic storage device, coupled to the bus 805 for storing information, and instructions to be executed by the processor 810. Main memory 815 can also be used for storing position information, temporary variables, or other intermediate information during execution of instructions by the processor 810. The computing system 800 may further include a read only memory (ROM) 810 or other static storage device coupled to the bus 805 for storing static information and instructions for the processor 810. A storage device 825, such as a solid state device, magnetic disk or optical disk, is coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information, and command selections to the processor 810. In another embodiment, the input device 830 has a touch screen display 835. The input device 830 can include a cursor control, such as a mouse, a trackball, or cursor direction keys, for communicating direction information and command selections to the processor 810 and for controlling cursor movement on the display 835.

According to various embodiments, the processes that effectuate illustrative embodiments that are described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative embodiments, hard-wired circuitry may be used in place of or in combination with software instructions to implement illustrative embodiments. Thus, embodiments are not limited to any specific combination of hardware circuitry and software.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
for an ad to be displayed on a web page, providing a first user input field that is selectable by a user viewing the ad;
upon detection of actuation of the first user input field for the ad, providing display data representing a second user input field by which a user can enter feedback information regarding the ad, the second user input field configured to receive input from the user regarding a specific portion of the ad;
receiving the feedback information regarding the ad that has been entered using the second user input field; and
storing the feedback information in association with the ad.

2. The method according to claim 1, wherein the providing comprises:
providing display data representing a display window by which the user can identify the specific portion of the ad.

3. The method according to claim 2, wherein the providing comprises:
providing a blocking option in the window configured to receive a user's request to hide personal information regarding the user from the feedback information, wherein the step of receiving the feedback information comprises receiving the feedback information without the personal information.

4. The method according to claim 2, further comprising:
providing display data representing a list of categories selectable in the window by the user to receive the feedback information.

5. The method according to claim 2, further comprising:
providing display data representing a text region in the window configured to receive text regarding the ad from the user.

6. The method according to claim 2, further comprising:
providing display data representing a preview option in the window configured to present the feedback information for preview by the user prior to sending the feedback information to a destination.

7. The method according to claim 1, wherein the first user input field corresponds to an icon provided at a predetermined position on each ad.

8. The method according to claim 7, wherein the predetermined position is a low right portion of each ad.

9. The method according to claim 1, further comprising:
accumulating the feedback information regarding the ad;
analyzing the accumulated feedback information regarding the ad; and
determining if an action regarding the ad is to be taken based on the analyzed feedback information.

10. The method according to claim 2, further comprising:
providing display data representing a drawing capability for the user configured to receive a markup of the specific portion of the ad,
wherein the marked-up ad is included in the feedback information associated with the ad.

11. A non-transitory computer readable medium storing computer program product, which, when executed by at least one computer, causes the at least one computer to perform the functions of:
for an ad to be displayed on a web page, providing a first user input field that is selectable by a user viewing the ad;
upon detection of actuation of the first user input field for the ad, providing display data representing a second user input field by which a user can enter feedback information regarding the ad, the second user input field comprising a portion configured to receive input from the user regarding a specific portion of the ad;
receiving the feedback information regarding the ad that has been entered using the second user input field; and
storing the feedback information in association with the ad.

12. The non-transitory computer readable medium according to claim 11, wherein the providing comprises:
providing display data representing a display window by which the user can identify the specific portion of the ad.

13. The non-transitory computer readable medium according to claim 12, wherein the providing comprises:
providing a blocking option in the window configured to receive a user's request to hide personal information regarding the user when from the feedback information.

14. The non-transitory computer readable medium according to claim 12, further comprising:
providing a list of categories selectable in the window by the user to receive the feedback information.

15. The non-transitory computer readable medium according to claim 12, further comprising:
providing a text region in the window configured to receive text regarding the ad from the user.

16. The non-transitory computer readable medium according to claim 12, further comprising:
providing a preview option in the window configured to present the feedback for preview by the user prior to sending the feedback information to a destination.

17. The non-transitory computer readable medium according to claim 11, wherein the first user input field corresponds to an icon provided at a predetermined position on each ad.

18. The non-transitory computer readable medium according to claim 17, wherein the predetermined position is a low right portion of each ad.

19. The non-transitory computer readable medium according to claim 11, further comprising:
accumulating the feedback information regarding the ad;
analyzing the accumulated feedback information regarding the ad; and
determining if an action regarding the ad is to be taken based on the analyzed feedback information.

20. The non-transitory computer readable medium according to claim 12, further comprising:
providing a drawing capability for the user to markup the specific portion of the ad,
wherein the marked-up ad is included in the feedback information associated with the ad.

21. A method comprising:
for an ad to be displayed on a web page, providing a first user input field that is selectable by a user viewing the ad, and providing display data representing a second user input field by which a user can enter feedback information regarding the ad, the display data being configured to display the second user input field upon detection of actuation of the first user input field, the second user input field further configured to receive input from the user regarding a specific portion of the ad;
receiving the feedback information regarding the ad that has been entered using the second user input field; and
storing the feedback information in association with the ad.

22. The method according to claim 21, wherein the providing comprises:
providing display data representing a display window by which the user can identify the specific portion of the ad.

23. The method according to claim 22, wherein the providing comprises:
providing a blocking option in the window configured to receive a user's request to hide personal information regarding the user from the feedback information, wherein the step of receiving the feedback information comprises receiving the feedback information without the personal information.

24. The method according to claim 22, further comprising:
providing display data representing a list of categories selectable in the window by the user to receive the feedback information.

25. The method according to claim 22, further comprising:
providing display data representing a preview option in the window configured to present the feedback information for preview by the user prior to sending the feedback information to a destination.

26. The method according to claim 21, further comprising:
accumulating the feedback information regarding the ad;
analyzing the accumulated feedback information regarding the ad; and
determining if an action regarding the ad is to be taken based on the analyzed feedback information.

27. A non-transitory computer readable medium storing computer program product, which, when executed by at least one computer, causes the at least one computer to perform the functions of:
for an ad to be displayed on a web page, providing a first user input field that is selectable by a user viewing the ad, and providing display data representing a second user input field by which a user can enter feedback information regarding the ad, the display data being configured to display the second user input field upon detection of actuation of the first user input field, the second user input field further configured to receive input from the user regarding a specific portion of the ad;
receiving the feedback information regarding the ad that has been entered using the second user input field; and
storing the feedback information in association with the ad.

28. The non-transitory computer readable medium according to claim 27, wherein the providing comprises:
providing display data representing a display window by which the user can identify the specific portion of the ad.

29. The non-transitory computer readable medium according to claim 28, wherein the providing comprises:
providing a blocking option in the window configured to receive a user's request to hide personal information regarding the user from the feedback information, wherein the step of receiving the feedback information comprises receiving the feedback information without the personal information.

30. The non-transitory computer readable medium according to claim 28, further comprising:
providing display data representing a list of categories selectable in the window by the user to receive the feedback information.

31. The non-transitory computer readable medium according to claim 28, further comprising:
providing display data representing a preview option in the window configured to present the feedback information for preview by the user prior to sending the feedback information to a destination.

32. The non-transitory computer readable medium according to claim 27, further comprising:
accumulating the feedback information regarding the ad;
analyzing the accumulated feedback information regarding the ad; and
determining if an action regarding the ad is to be taken based on the analyzed feedback information.
